(19) United States
(12) Patent Application Publication
(10) Pub. No.: US 2005/0223760 A1
(43) Pub. Date: Oct. 13, 2005

(54) Safety lock for glass doors

(76) Inventor: Antonio Augusto Ferreira Vieira Leite, PORTO (PT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/507,724

(22) PCT Filed: Feb. 25, 2003
(86) PCT No.: PCT/PT03/00001

§ 371 Date: May 27, 2005

(30) Foreign Application Priority Data
Mar. 4, 2002 (PT) 9792

(51) Int. Cl. E05B 65/06

(52) U.S. Cl. 70/134

(57) ABSTRACT

The present invention refers to a safety lock for glass doors with a standard cut. This lock has two covers (1 and 9) and a strike plate (13), defining an internal space, inside which it is the lock mechanism of reduce dimensions, where the Hungarian type lock cylinder (11) is firmly attached. The lock mechanism is comprised by part of the base cover (1), which perpendicular walls to the base form a substantially rectangular box, having two crenellated parallel walls and perpendicular to the strike plate (13). Inside this box is arranged an internal mechanism comprised by a grooved lower plate (2), a locking plate (3), a pin (4), a spring (5) and a grooved upper plate (7) the grooves in the lower and upper plates being matched one another. The locking plate (3) has in one tip a shaft and one teeth formation in the external periphery the spring (5) being fitted into a recess in the locking plate (3), adjacent to the place where is fixed the pin (4) which is used for securing the locking plate (3) in the lower and upper plates (2, 7) of the internal mechanism.

The present invention concerns a safety lock especially for glass doors having a standard cut which is more simple than the existent locks. The lock according present invention although being designed for glass doors it can have other applications in association with different suitable covers.

The invention is characterized by a special construction of the lock mechanism, which allows a space reduction that it occupies, and the possibility of more than one turn of the lock cylinder.

Locks for glass doors are well known in the art and used all over the world, so being known the difficulties presented by this type of locks when applied to toughened glass doors with a standard cut having a thickness ranging from 8 to 12 mm. This cut is of reduced dimensions, which reduces drastically the size of the lock, restrained until now the use in this kind of lock a lock cylinder such us a Hungarian type lock cylinder.

The object of the present invention is a safety lock for glass doors made of toughened glass, being intended to be applied particularly to glass doors with a standard cut having a thickness ranging from 8 to 12 mm. This safety lock could also have other applications. The object of the invention is a lock having reduced dimensions (width and height) that could be associated with any kind of lock cylinder, for example, a Hungarian type lock cylinder.

This lock is comprised by case means having two covers and one strike plate, which define a internal space, inside which is the lock mechanism and the lock cylinder. This mechanism is comprised by fixed locking means, comprised by a box associated with one of said covers preferably of quadrangular shape bounded by a wall having a suitable thickness preferably having a quadrangular section with at least a rectilinear crenellated formation, preferably with two paralleled walls of this type and internal locking means, which coupled with the driven means through drag means linked to the lock cylinder means. These driven means are moved forward and backward according to the action of the above-mentioned drag means into one tooth formation, located in the internal periphery of the driven means. The internal locking means is moved by the drag means of the above mentioned lock cylinder means and are locked into said crenellated formation by the engagement of said tooth type formations, disposed in its periphery. Locking and unlocking the said internal locking means, is made by their rotation around a shaft, which is disposed in its periphery and by pressure of spring means which is adjacent to the shaft. The bolt means are associated with said driven means and are moved forward or backward synchronized with the said driven means. The use of these new means, allows the use of any lock cylinder means, for example of Hungarian type, enabling then the use of master keys, further enabling the use in doors opening either from the right or from the left, all one has to do is to reverse the internal mechanism. Finally, these means offer a high level of security and reliability because they are totally inside the lock and the lock cylinder means being protected by said case means.

For a better understanding an embodiment of the invention will be disclosed in detail as a non-limitative example illustrated in the appended drawings, in which:

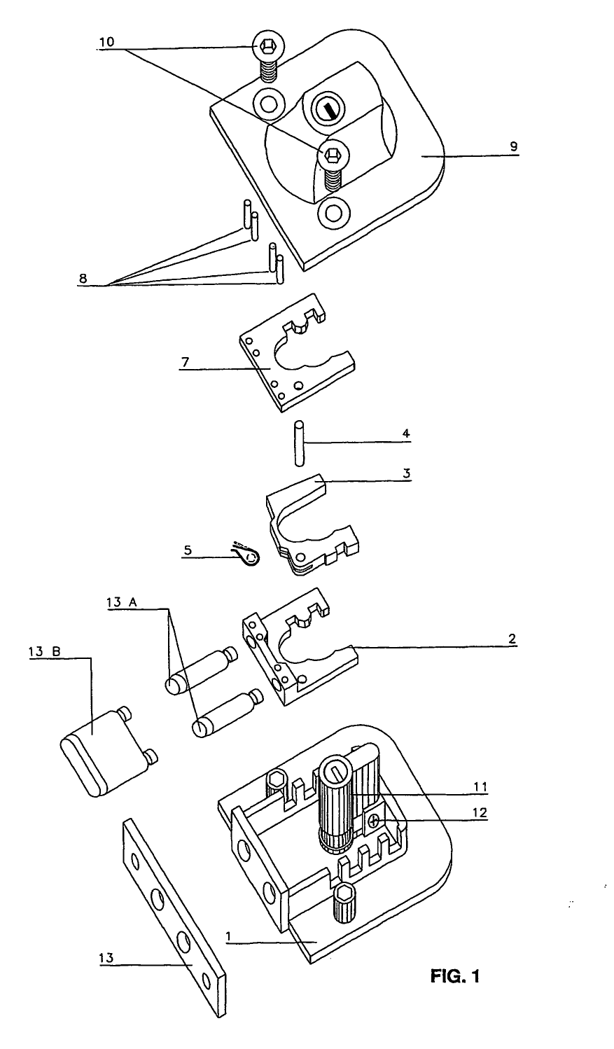

FIG. 1 is a exploded perspective view of the lock, according to the present invention;

FIG. 2 is a lateral elevation view of the lock base plate with the fixed lock cylinder;

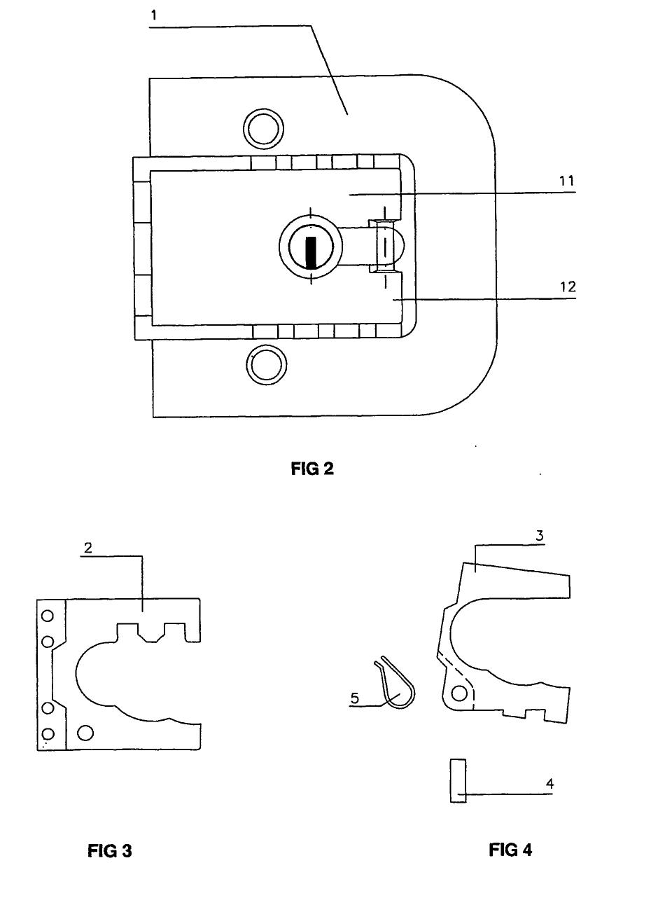

FIG. 3 is a lateral elevation view of the internal mechanism lower plate;

FIG. 4 is a lateral elevation view of the lock plate, the associated spring and the retaining pin of the lock plate;

FIG. 5 shows two types lock bolts: rods and bolts;

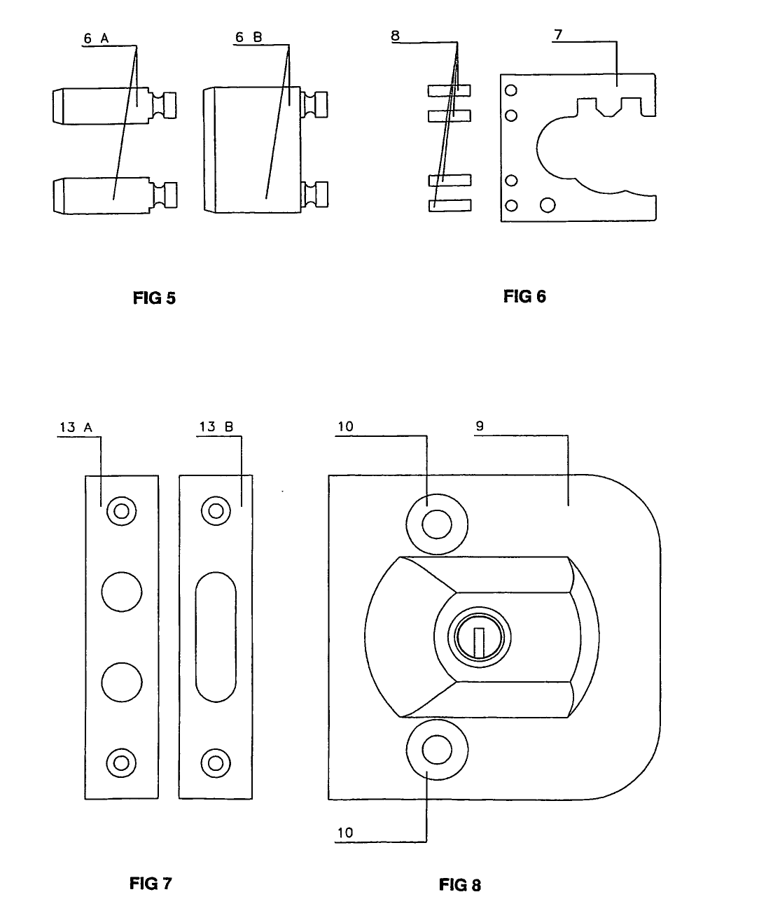

FIG. 6 is a lateral elevation view of the internal mechanism upper plate also being shown the retention pins into the lower plate;

FIG. 7 is a frontal view of the strike plate of the lock;

FIG. 8 is a frontal view of the lock cover showing the attaching screws;

FIG. 9 is a lateral elevation view of the lock mechanism in the open condition;

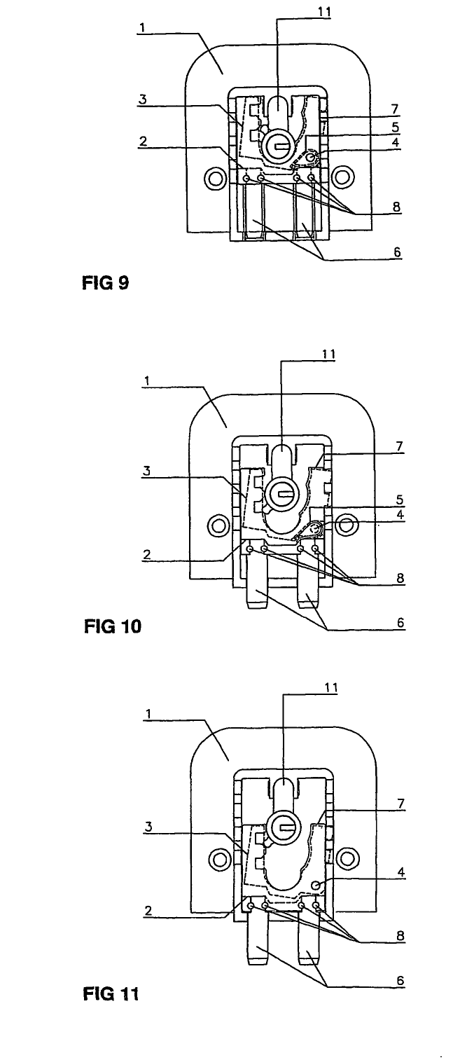

FIG. 10 is a lateral elevation view of the lock mechanism in the intermediated lock condition, after a first turn of the lock cylinder;

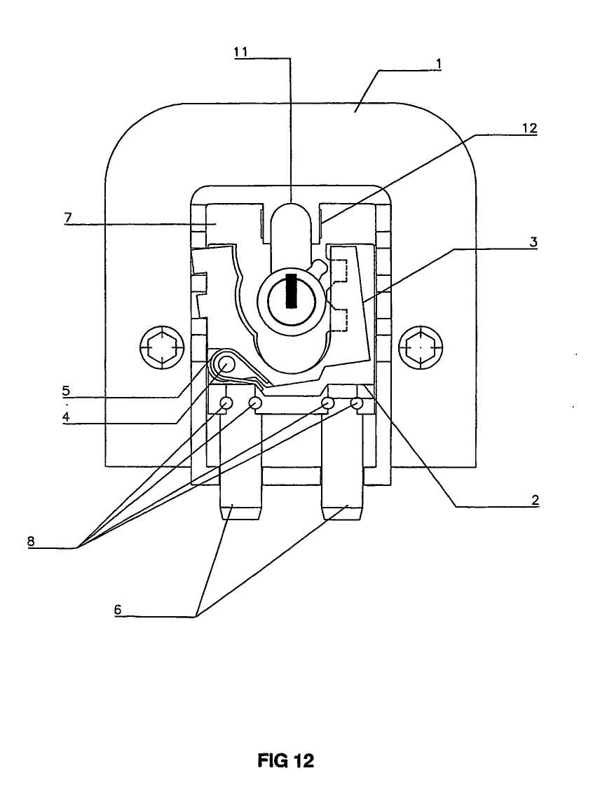

FIG. 11 is a lateral elevation view of the lock mechanism in the final lock condition, after a second turn of the lock cylinder;

FIG. 12 is a lateral elevation view with the internal mechanism reversed;

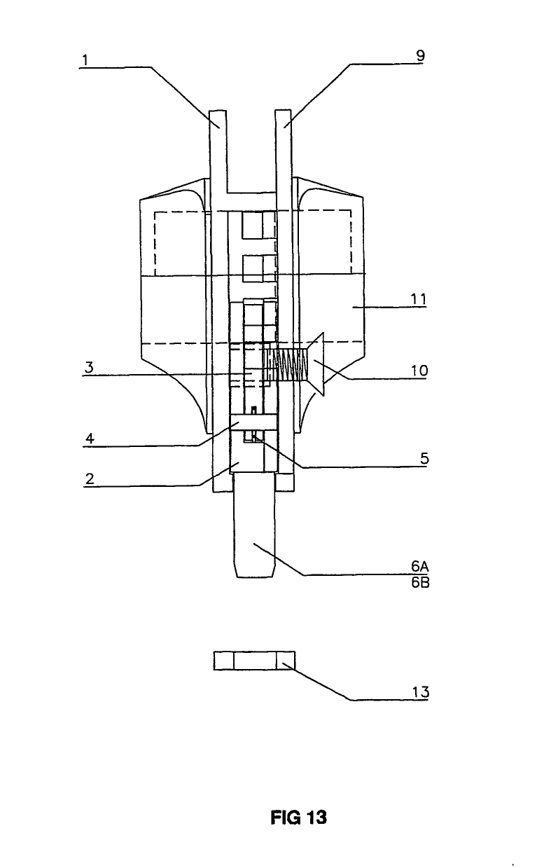

FIG. 13 is (longitudinal) top view of the installation of the lock on a glass door; and

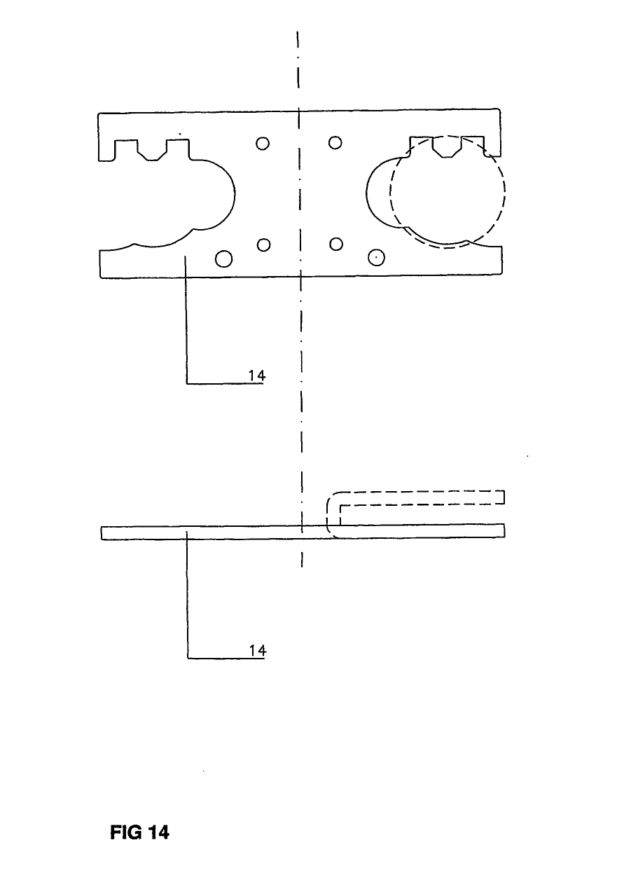

FIG. 14 is a frontal view and a lateral view of a further embodiment of the lock mechanism upper and lower plates merged in a single piece.

In the FIG. 1 is represented an embodiment of the safety lock according the present invention, intended for use in glass doors with a standard cut having a thickness ranging from 8 to 12 mm. The lock has two covers 1 and 9 and one strike plate 13 defining an internal space inside which it is the lock mechanism of reduce dimensions, where the Hungarian type lock cylinder 11 is firmly attached by two screws 12. The lock mechanism is comprised by part of the base cover 1, which perpendicular walls to the base form a substantially rectangular box, having two crenellated parallel walls and perpendicular to the strike plate 13. Inside this box is arranged an internal mechanism comprised by a grooved lower plate 2, a locking plate 3, a pin 4, a spring 5 and a grooved upper plate 7 the grooves in the lower and upper plates being matched one another. Associated with the said plates 2 and 7 through the retaining pins 8, is placed a lock bolt 6 which can have two rods. The lock cover 9 is attached to the base cover 1 and to the lock strike plate 13 by the screws 10. The locking plate 3 has in one tip a shaft and one teeth formation in the external periphery the spring 5 being fitted into a recess in the locking plate 3, adjacent to the place where is fixed the pin 4 which is used for securing the locking plate 3 in the lower and upper plates 2, 7 of the internal mechanism. This pin is the shaft of the locking plate 3 and matches with the spring 5 axis.

In FIG. 14 is shown further embodiment of the internal mechanism, in which the lower and upper plates 2, 7 were merged in a single piece.

When the drag piece of the lock cylinder 11 is turned, it drives the locking plate 3, taking off its teeth from the crenellated formation of said box, releasing it from the first locked position (FIG. 9), and engages into the first grooves of lower 2 and upper 7 plates of the internal mechanism, displacing it with the associated lock bolt 6A or 6B (FIG. 10) of a first distance, the locking plate 3 being locked through the pressure of the spring 5 in its second position (FIG. 10), just when the lock drag piece cease acting on said locking plate 3.

Repeating the turning movement of the cylinder 11 once more, its drag piece drives again on said locking plate 3, releasing it from the second locking position (FIG. 10), and engages it into the second grooves of internal mechanism lower and upper plates 2, 7, moving the said internal mechanism with the associated lock bolt 6A or 6B (FIG. 11) of a second distance, said locking plate 3 being locked again, by the pressure of the spring 5 in the third position (FIG. 11), when said drag piece cease driving on said locking plate 3, which releases the internal mechanism 2, 3, 4, 5, 6, 7 and 8 and is the action of said spring 5 on said locking plate 3 that locks the internal mechanism 2, 3, 4, 5, 6, 7 and 8 in all its conditions: the open condition (FIG. 9), the intermediate lock condition after the first turn (FIG. 10) and the final lock condition after the second turn (FIG. 12).

This lock is different from the others, because the locking plate 3 is driven on its inner periphery and locks through its outer periphery.

The said cover 9 (FIG. 1) has a special shape in order to house inside it said lock cylinder 11.

This present invention lock can work in doors that open either from the right (FIG. 12) or from left (FIG. 9), being sufficient to reverse its internal mechanism (2, 3, 4, 5, 6, 7 and 8), cf. FIG. 12.

1- Safety lock for doors specially for glass doors with a standard cut, including two covers (1, 9) and one strike plate (13), which define an inner space, inside which is the lock mechanism of reduce dimensions, and a lock cylinder (11), which includes a drag piece characterized in that the said lock mechanism which is comprised by part of the base cover (1), which perpendicular walls to the base form a substantially rectangular box; having two crenellated parallel walls and perpendicular to said strike plate (13), in that inside said box is arranged an internal mechanism comprised by a grooved lower plate (2), a locking plate (3), a pin (4), a spring (5) and a grooved upper plate (7), the grooves in the lower and upper plates (2, 7) being matched one another, a lock bolt (6A, 6B) being attached to the lower and upper plates (2 and 7), though the retaining pins (8), in that the locking plate (3) has a side hole where the bolt (4) is housed, and a teeth formation in the external periphery the spring (5) being fitted into a recess of the locking plate (3) adjacent to the pin (4), this pin (4) being housed into holes in the lower (2) and upper plate (7) of said internal mechanism, the said pin being the axis of said spring (5) and the rotation shaft of the locking plate (3), in that when said drag piece of the said lock cylinder (11) is turned it drives said locking plate (3), when is fastened or unfastened, taking off its teeth from the crenellated from crenellated formation of said box, releasing it from the first locking position and engages into first grooves of lower (2) and upper (7) plates of the internal mechanism, displacing it with the associated lock bolt (6A or 6B) of a first distance, the locking plate being locked through pressure of the spring (5) in its second position into the crenellated formation, just when the drag piece does not drive the locking bolt (3), repeating the turning movement of the cylinder (11), its drag piece drives again on the locking plate (3), releasing it from the second locking position, and engages it into the second grooves of internal mechanism lower and upper plates (2, 7), moving said internal mechanism with the associated latch bolt (6A or 6B) of a second distance, said locking plate (3) being blocked again, by the pressure of the spring (5) in a third position.

2- Safety lock in agreement with the claim 1, characterized in that the action of said drag piece of the cylinder (11) on said locking plate (3) releases said internal mechanism (2, 3, 4, 5, 6, 7 and 8) and the pressure of the said spring (5) on the locking plate (3) locking the inner mechanism (2, 3, 4, 5, 6, 7 and 8) in all its conditions, the open condition, the intermediate lock condition after the first turn and final lock condition after the second turn.

3- Safety lock according to any previous claim, characterized in that said locking plate (3), is driven on its internal periphery and locks through its outer periphery.

4. Safety lock according to any previous claim, characterized in that it works in doors that open either from the right or from left, being sufficient to reverse its internal mechanism (2, 3, 4, 5, 6, 7 and 8).

5- Safety lock according to any previous claim, characterized in that said internal mechanism lower and upper plates (2, 7) are merged in a single piece.

6- Safety lock according to any previous claim, characterized in that said lock cylinder (11) is a Hungarian type lock cylinder.
